(19) United States
(12) Patent Application Publication
(10) Pub. No.: US 2009/0054122 A1
(43) Pub. Date: Feb. 26, 2009

(54) Gaming Machine With A Bonus Game Installed And Method Of Playing A Game

(75) Inventor: Hiroki SAITO, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: ARUZE CORP., Tokyo (JP)

(21) Appl. No.: 12/194,017

(22) Filed: Aug. 19, 2008

(30) Foreign Application Priority Data
Aug. 22, 2007 (JP) JP2007-215699

(51) Int. Cl. A63F 9/24; A63F 13/00

(52) U.S. Cl. 463/6

(57) ABSTRACT

To players who executed BET on a race of a horse racing game that is a main game, a bonus game that starts and ends after the race is randomly generated. If a bonus game is generated, a bonus game image in which a plurality of choices W1 to W6 are provided is displayed on a sub monitor 113. While an overall view of a race track of the horse racing game is displayed in each choice W1 to W6, order of arrival and award amount are related in the undisplayed state. The each choice W1 to W6 is selected when a player touches it via a touch panel 114, and then the order of arrival and award amount of the selected target are displayed. Provided that the player has selected only the first place for a predetermined number of times, the player is provided with award amount corresponding to them.

### CROSS-REFERENCE TO RELATED APPLICATIONS

This application is based upon and claims a priority from the prior Japanese Patent Application No. 2007-215699 filed on Aug. 22, 2007, the entire contents of which are incorporated herein by reference.

### BACKGROUND

1. Field

The present invention relates to a gaming machine with a bonus game installed and a method of playing a game.

2. Description of Related Art

In a conventional racing game, in a mass game in which a number of players participate, a period of time of a racing game on which the players bet is idle time for them, because during the period they are not allowed to perform any operation that may affect the result of that game.

There are the following as document information of the prior art related to a conventional racing game: U.S. Pat. No. 6,210,275B1, U.S. Pat. No. 6,358,150B1, U.S. Pat. No. 6,450,887B1, U.S. Pat. No. 6,634,944B2, U.S. Pat. No. 6,848,991B2, U.S. Pat. No. 6,905,410B2, U.S. Pat. No. 6,921,331B2, U.S. Pat. No. 6,929,550B2, U.S. Pat. No. 6,962,529B2, U.S. Pat. No. 7,025,353B2, U.S. Pat. No. 7,172,508B2.

Thus, if a horse racing game modeled on a real race to pursue reality wherein a period of time from the start to the end of a racing game was similar to that of a real horse race, not a few players would feel that the game period was slow and prolonged, and it is thus difficult to provide them with a sense of tension during or after a racing game.

### SUMMARY

The present invention has been conceived in view of the above circumstance and its object is to provide, by improving ability of entertainment during or after a racing game through a novel, unprecedented bonus game, us with a gaming machine with the bonus game installed, and a method of playing a game.

To achieve the object of the disclosure, there is provided a gaming machine, comprising: a main monitor on which a racing game is displayed; a plurality of stations respectively provided with a sub monitor on which play information on the racing game is displayed and an input device which accepts a bet operation by a player for the racing game; and a processor which controls the main monitor and the plurality of stations and is programmed, to the stations where the player executed the bet operation for the racing game with the input device, to execute the following processes from (a) to (c): (a) randomly determining whether or not to execute a bonus game before starting the racing game on the main monitor; (b) starting the bonus game on the sub monitor when it is determined in the (a) that the bonus game is executed; and (c) awarding the player a prize depending on the result of the bonus game which was progressed based on the input operation of the player through the input device.

Furthermore, according to another aspect, there is provided a method of playing a game, comprising: the following steps from (a) to (c) for a player who bet on a racing game: (a) randomly determining whether or not to execute a bonus game before starting the racing game; (b) starting the bonus game when it is determined in the (a) that the bonus game is executed; and (c) awarding the player a prize depending to the result of the bonus game that was progressed based on instructions of the player.

### BRIEF DESCRIPTION OF THE DRAWINGS

FIG. 1 is a diagram for illustrating characteristics of a gaming machine according to one embodiment of the present invention and is a front view showing examples of bonus game images to be displayed on a sub monitor;

FIG. 2 is a perspective view of the gaming machine;

FIG. 3 is a perspective view of a station;

FIG. 4 is a block diagram of a main game unit;

FIG. 5 is a block diagram of the station;

FIG. 6 is a flow chart showing one example of game operations in the gaming machine;

FIG. 7 is a front view showing one example of BET images to be displayed on the sub monitor;

FIG. 8 is a flow chart showing one example of a bonus game process;

FIG. 9 is a view showing one example of orders of arrival and award amounts related to respective choices on the bonus game image;

FIG. 10 is a front view showing one example of the bonus game image to be displayed on the sub monitor;

FIG. 11 is a flow chart showing one example of the bonus game process;

FIG. 12 is a view showing one example of orders of arrival and award amounts related to respective choices on the bonus game image;

FIG. 13 is a front view showing one example of the bonus game image to be displayed on the sub monitor;

FIG. 14 is a flow chart showing one example of the bonus game process;

FIG. 15 is a front view showing one example of the bonus game image to be displayed on the sub monitor;

FIG. 16 is a front view showing one example of the bonus game image to be displayed on the sub monitor;

FIG. 17 is a flow chart showing one example of game operations in the gaming machine.

### DETAILED DESCRIPTION

### [1. Characteristics of a Gaming Machine]

In the following, a description is made on embodiments of the present invention with reference to the drawings.

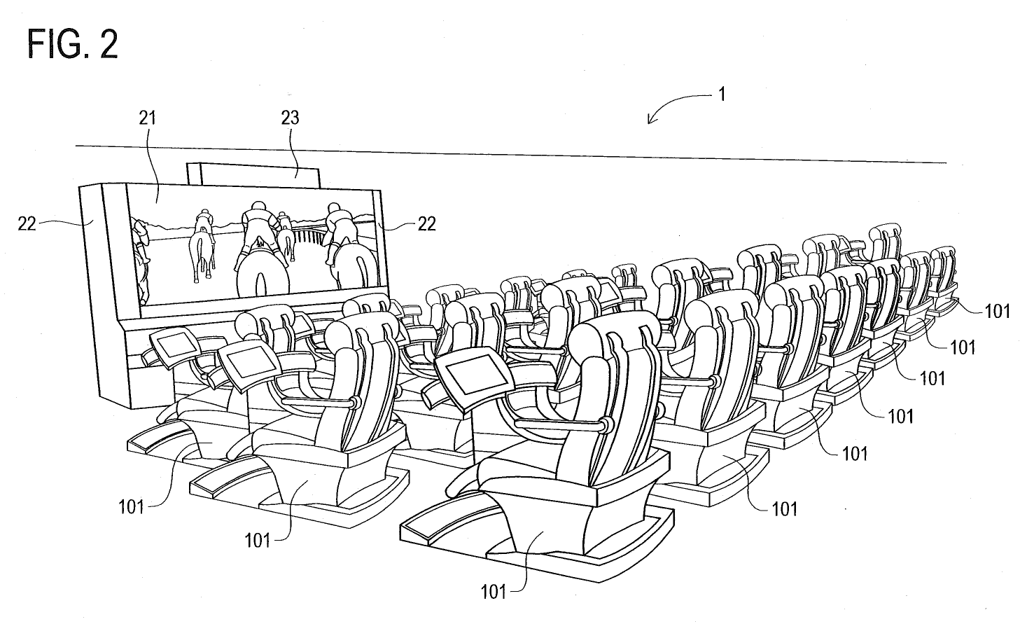

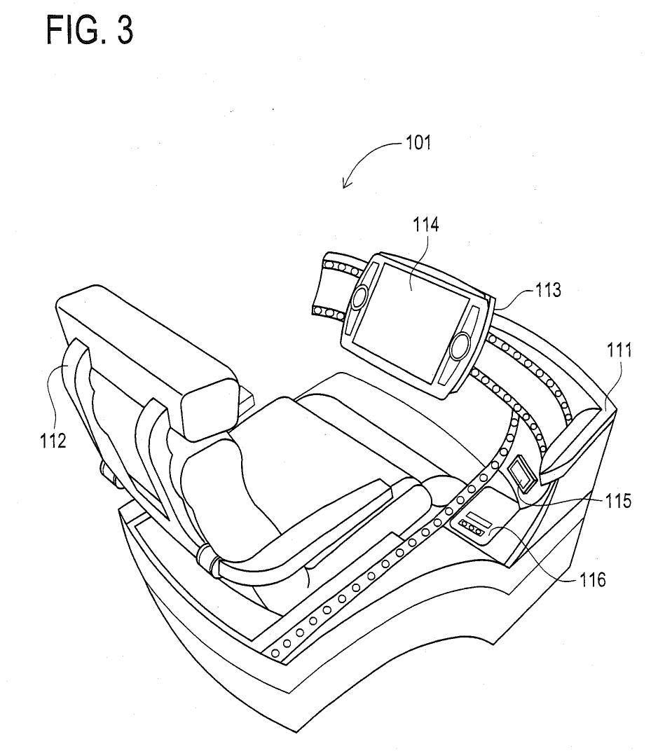

FIG. 2 is a perspective view of a gaming machine 1 that is one embodiment of the present invention. As shown in FIG. 2, the gaming machine 1 of this embodiment has a main monitor 21 and a number of stations 101. Images of a horse racing game are displayed as a main game on the main monitor 21. Each of players being seated at the respective stations 101 can participate in this horse racing game. The players being seated at the respective stations 101 participate in this horse racing game by forecasting the result of each race of the horse racing game and executing BET operation. FIG. 3 is a perspective view of the station 101. To execute BET operation, a player uses a sub monitor 113 or a touch panel 114 equipped to the each of the stations 101.

In this respect, in the gaming machine 1 of this embodiment, a player can execute BET on a race result before or during the race. In a station 101 where a player who has already executed BET before a race starts, a bonus game that starts and ends after the race may be executed.

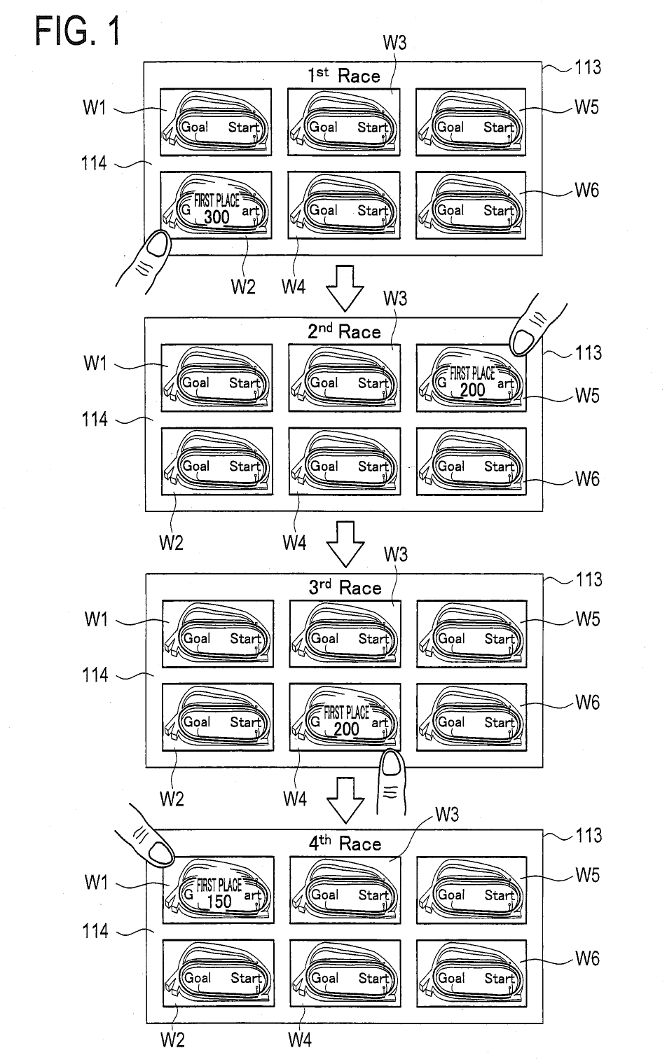

Illustrating characteristics of the gaming machine 1 of this embodiment, FIG. 1 is a front view showing examples of bonus game images to be displayed on the sub monitor 113. As shown in the top column of FIG. 1, in the station 101 where a bonus game is generated, first, a bonus game image in which a plurality of choices W1 to W6 are provided is displayed as a first round on the sub monitor 113. While an overall view of the race track is displayed in each choice W1 to W6, any of orders of arrival and award amounts of the first to third places are not displayed although the order of arrival of any of the first to third places and the award amount (only the first place) are related.

When the player touches any one of the plurality of choices W1 to W6 via the touch panel 114, the order of arrival and the award amount thereof are displayed on the sub monitor 113. Then, if the first place is displayed, the player can proceed to a next round. As such, the player can proceed to the second round on the second column from the top in FIG. 1, the third round on the third column from the second in FIG. 1 and the fourth round on the fourth column from the third in FIG. 1 in this order. In the fourth round, on the condition that the player makes selections in this round before the time limit of this bonus game, when the first place is displayed, the award amounts of respective rounds are summed up and added to a credit amount.

### [2. Appearance of a Gaming Machine]

As shown in FIG. 2, the gaming machine 1 of this embodiment has the main monitor 21, speakers 22, a display device 23, the plurality of stations 101, etc. The main monitor 21 displays images of a horse racing game, etc. The speakers 22 output sound of a horse racing game, etc. The display device 23 displays information about games in general.

As shown in FIG. 3, in each station 101, a cabinet 111 is provided with a chair 112, the sub monitor 113, the touch panel 114, a bill identifying device 115, a ticket printer 116, etc. A player sits on the chair 112. The sub monitor 113 displays BET images to be described later or images of the aforementioned bonus game, etc. The touch panel 114 is provided on the screen of the sub monitor 113 and used when the player executes the BET operation utilizing the BET images to be described later or selection operation utilizing the aforementioned bonus game images.

The bill identifying device 115 not only identifies whether or not a bill is appropriate but also receives legitimate bills into a cabinet 111. Then, bills inserted into the cabinet 111 are converted into the number of coins, and the credit amount that corresponds to the converted number of coins is added as the player's own credit amount. The bill identifying device 115 is also configured to be capable of reading bar coded tickets to be described later.

The ticket printer 116 is a printer that prints on a ticket a bar code representative of coded data such as a player's own credit amount, date, identification number of the station 101, etc. and outputs it as a bar coded ticket. A player can have the outputted bar coded ticket read by other station 101 and play at this other station 101, or use it for any procedure in predetermined places in a game arcade.

### [3. Example of Configuration of Main Game Unit]

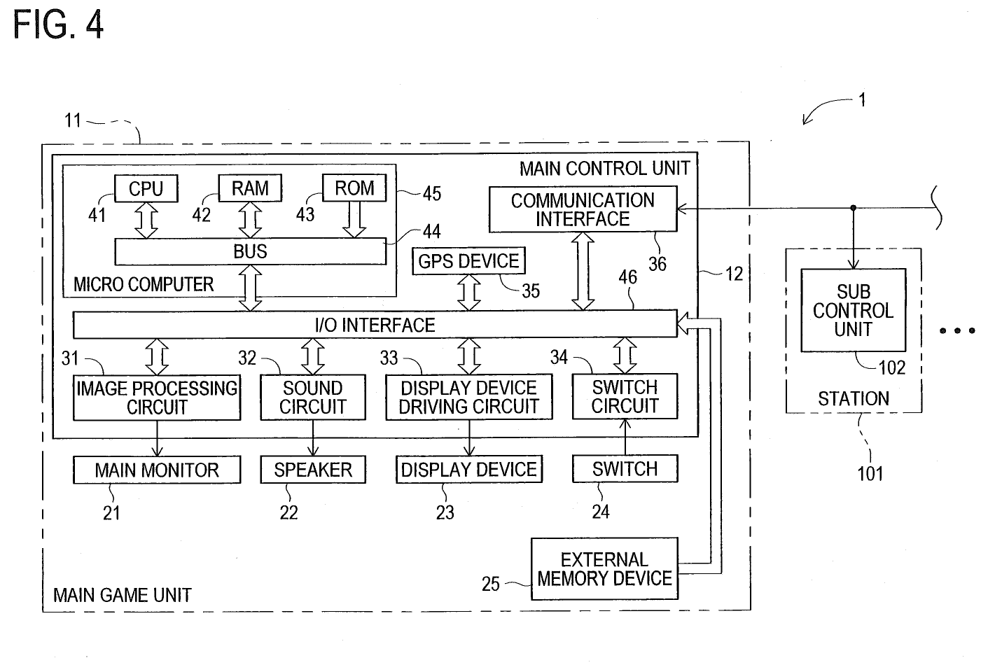

A main game unit is a concept of each station 101 and constitutes a core of the gaming machine 1 of this embodiment. FIG. 4 is a block diagram of the main game unit 11. As shown in FIG. 4, the main game unit 11 is composed of a main control unit 12, the main monitor 21, the speakers 22, the display device 23, a switch 24, an external memory device 25, etc. The main control unit 12 and external memory device 25 are provided separately from the main monitor 21, speakers 22, or display device 23. Although the switch 24 is annexed to the main control unit 21, it may be provided individually.

The main control unit 12 is generally composed of a microcomputer 45 as the kernel comprising a CPU 41, a RAM 42, a ROM 43 and a bus 44 for transferring data mutually between these elements. The RAM 42 and the ROM 43 are connected to the CPU 41 via the bus 44. The RAM 42 is a memory for temporarily storing a variety of data which have been operated in the CPU 41. The ROM 43 stores various types of programs, data tables or the like for executing necessary processes to control the gaming machine 1.

An image processing circuit 31 is connected to the microcomputer 45 via an I/O interface 46. The image processing circuit 31 is connected to the main monitor 21 and controls driving of the main monitor 21.

The image processing circuit 31 is composed of a program ROM, an image ROM, an image control CPU, a work RAM, a VDP (video display processor), and a video RAM, etc. And in the program ROM, an image control program related to display on the main monitor 21, and various selection tables are stored. And, in the image ROM, dot data to form images and the like, for example dot data to form images displayed on the main monitor 21, are stored. And, based on parameters set by the microcomputer 45, the image control CPU determines the images displayed on the main monitor 21 among the dot data stored beforehand in the image ROM, according to the image control program stored beforehand in the program ROM. And, the work RAM works as a temporary memory when the image control program is executed in the image control CPU. And the VDP forms images corresponding to display contents determined by the image control CPU. And the VDP outputs the images formed thereby to the main monitor 21. And the video RAM works as a temporary memory when the images are formed by the VDP.

A sound circuit 32 is connected to the microcomputer 45 via the I/O interface 46. The speakers 22 are connected to the sound circuit 32 and are arranged on both lateral sides of the main monitor 21. The speakers 22 output various types of effect sound, BGM, etc. when various types of effect are performed, by being subjected to output control by the sound circuit 32 based on a drive signal from the CPU 41.

A display device driving circuit 33 is connected to the microcomputer 45 via the I/O interface 46. The display device 23 is connected to the display device driving circuit 33. The display device 23 is disposed on the upper side of the main monitor 21 and displays information about games in general, by being subjected to display control by the display device driving circuit 33 based on a drive signal from the CPU 41.

A switch circuit 34 is connected to the microcomputer 45 via the I/O interface 46. The switch 24 is connected to the switch circuit 34 and is arranged in the lower part of the main monitor 21. The switch 24 inputs an instruction by an operator's setting operation into the CPU 41 based on a switch signal from the switch circuit 34.

An external memory device 25 is connected to the microcomputer 45 via the I/O interface 46. The external memory device 25 is arranged in the periphery of the main monitor 21 and has capability similar to the image ROM in the image processing circuit 31, by storing dot data for forming images, such as dot data for forming images on the main monitor 21. Thus, when determining any image to be displayed on the main monitor 21, the image control CPU in the image processing circuit 31 also includes the dot data stored in advance in the external memory device 25, as a target of determination.

A GPS device 35 is connected to the microcomputer 45 via the I/O interface 46. The GPS device 35 outputs a current position of the gaming machine 1 of this embodiment as longitude and latitude data, by receiving a radio signal from the GPS satellite comprising a global positioning system.

A communication interface 36 is connected to the microcomputer 45 via the I/O interface 46. A sub control unit 102 of each station 101 is connected to the communication interface 36. This enables bidirectional communication between the CPU 41 and each station 101. The CPU 41 can receive and transmit a command, request and data from/to each station 101 via the communication interface 36. Therefore, in the gaming machine 1, the main control unit 12 controls progress of the horse racing game in cooperation with each station 101.

### [4. Example of Configuration of a Station]

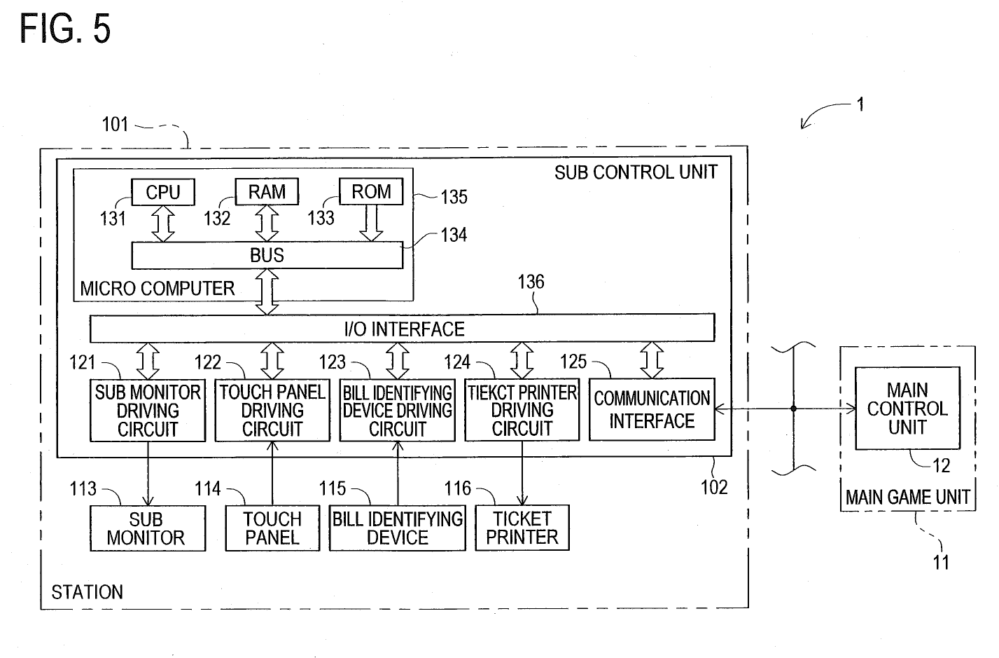

FIG. 5 is a block diagram of a station 101. As shown in FIG. 5, the station 101 is composed of the sub control unit 102, the sub monitor 113, the touch panel 114, the bill identifying device 115, the ticket printer 116, etc.

The sub control unit 102 is generally composed of a microcomputer 135 as the kernel comprising a CPU 131, a RAM 132, a ROM 133 and a bus 134 for transferring data mutually between these elements. The RAM 132 and the ROM 133 are connected to the CPU 131 via the bus 134. The RAM 132 is a memory for temporarily storing a variety of data which have been operated in the CPU 131. The ROM 133 stores various types of programs, data tables or the like for executing necessary processes to control the gaming machine 1.

A sub monitor driving circuit 121 is connected to the microcomputer 135 via an I/O interface 136. The sub monitor 113 is connected to the sub monitor driving circuit 121. The sub monitor driving circuit 121 controls driving of the sub monitor 113 based on a drive signal from the aforementioned main game unit 11. The sub monitor driving circuit 121 has also similar configuration and capabilities to the image processing circuit 31 as shown in the FIG. 4 above, and controls driving of the sub monitor 113 so that images of the aforementioned bonus game or BET images to be described later are displayed.

A touch panel driving circuit 122 is connected to the microcomputer 135 via the I/O interface 136. The touch panel 114 is connected to the touch panel driving circuit 122 and is arranged on the screen of the sub monitor 113. The touch panel 114 inputs an instruction into the CPU 131 through touch operation of a player (touch position), based on a coordinate signal from the touch panel driving circuit 122.

A bill identifying driving circuit 123 is connected to the microcomputer 135 via the I/O interface 136. The bill identifying device 115 is connected to the bill identifying driving circuit 123. The bill identifying device 115 identifies whether or not a bill or a bar coded ticket is appropriate. When receiving a legitimate bill, the bill identifying device 115 inputs an amount of the bill into the CPU 131 based on an identification signal from the bill identifying driving circuit 123. In addition, when receiving a legitimate bar coded ticket, the bill identifying device 115 inputs a credit amount, etc. recorded on the bar coded ticket into the CPU 131 based on an identification signal from the bill identifying driving circuit 123.

A ticket printer driving circuit 124 is connected to the microcomputer 135 via the I/O interface 136. The ticket printer 116 is connected to the ticket printer driving circuit 124. The ticket printer 116 prints on a ticket a bar code representative of coded data such as owned credit amount, etc., stored in the RAM 132, and outputs it as a bar coded ticket, by being subjected to output control by the ticket printer driving circuit 124 based on a drive signal to be outputted from the CPU 131.

A communication interface 125 is connected to the microcomputer 135 via the I/O interface 136. The main control unit 12 of the main game unit 11 is connected to the communication interface 125. This enables bidirectional communication between the CPU 131 and the main game unit 11. The CPU 131 can receive and transmit a command, request and data from/to the main game unit 11 via the communication interface 125. Therefore, in the gaming machine 1, the sub control unit 102 controls progress of the horse racing game in cooperation with the main game unit 11.

### [5. Example of Game Operations of a Gaming Machine]

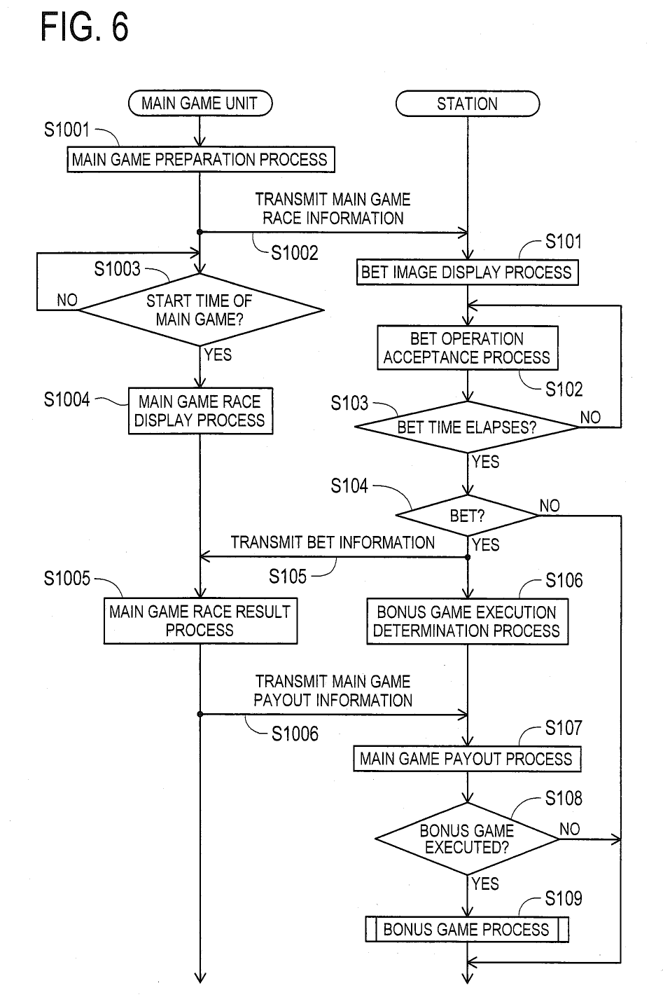

In the following, a description is made on an example of game operations of the gaming machine 1 of this embodiment. FIG. 6 is a flow chart showing one example of game operations in the gaming machine 1 of this embodiment. In addition, respective stations 101 execute similar game operations respectively in cooperation with the main game unit 11. In order to avoid any complication, however, only one station 101 is shown in FIG. 6.

The main game unit 11 executes respective operations from S1001 to S1006. First, in S1001, the main control unit 12 executes a main game preparation process. In this process, for a horse racing game that is a main game, the CPU 41 determines a track, starter horse, start time, etc. of this race, and reads data on them from the ROM 43.

In S1002, the main control unit 12 transmits main game race information. In this transmission, the CPU 41 transmits each data on the track, starter horse, start time, etc. of this race to each station 101, as main game race information.

In S1003, the main control unit 12 determines whether or not the present time is race start time of the main game. In this determination, the CPU 41 checks time until the time to start this race is reached (S1003: NO).

The CPU 41 may also determine whether or not the present time is the time to start this race, by timing an interval from the last race.

When the time to start this race is reached (S1003: YES), the main control unit 12 proceeds to S1004 and executes a main game race display process. In this process, based on the determination in S1001 above, the CPU 41 not only displays race images of this race on the main monitor 21 but also outputs sound of this race from the speakers 22.

In S1005, the main control unit 12 executes a main game race result process. In this process, the CPU 41 computes payout amount of each station 101 based on data on race result in S1004 above or BET information transmitted by each station 101 in S105 to be described later.

In S1006, the main control unit 12 transmits main game payout information. In this transmission, the CPU 41 transmits each payout amount, etc. in S1005 above to the corresponding station 101 as main game payout information. Afterward, similar processes are repeated in subsequent races.

On the one hand, each station 101 executes respective operations S101 to S108.

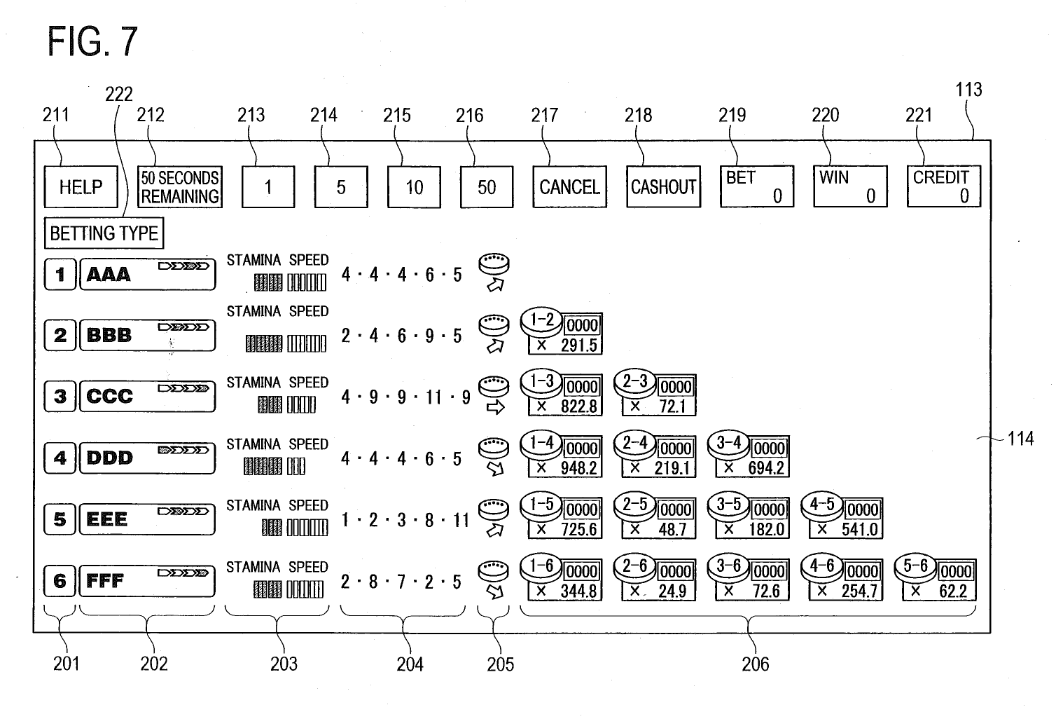

First, in S101, the sub control unit 102 executes a BET image display process. In this process, the CPU 131 displays BET images of this race on the sub monitor 113 based on the data on the main game race information transmitted by the main game unit 11 in S1002 above. FIG. 7 shows one example of the BET images to be displayed on the sub monitor 113.

As shown in FIG. 7, on a BET image to be displayed on the screen of the sub monitor 113 covered by the light transmissive colorless touch panel 114 are provided a horse number display area 201, a horse name display area 202, a basic power display area 203 that displays speed and stamina by a bar graph, a performance display area 204 that displays orders of arrival in last five races, a brief comment display area 205 that displays the condition of this race by an arrow, a betting ticket purchase button display area 206 where a betting ticket purchase button of a quinella-type bet in which a player randomly picks a combination of horse of numbers that will finish in the first place and in the second place in order to win, odds or BET amounts are displayed together, etc.

In addition, on the BET image are provided a help button 211, a remaining bet time display area 212, a 1 BET button 213, a 5 BET button 214, a 10 BET button 215, a 50 BET button 216, a cancel button 217, a CASHOUT button 218, a BET amount display area 219, a payout amount display area 220, a credit amount display area 221, a betting type switch button 222, etc.

The help button 211 is a button that a player touches to display a method of manipulating BET, etc. on the sub monitor 113. The remaining bet time display area 212 displays BET time in terms of how much time remains. The 1 BET button 213 is a button that a player touches to set so that “1” is added to the present BET amount. The 5 BET button 214 is a button that a player touches to set so that “5” is added to the present BET amount. The 10 BET button 215 is a button that a player touches to set so that “10” is added to the present BET amount. The 50 BET button 216 is a button that a player touches to set so that “50” is added to the present BET amount.

The cancel button 217 is a button that a player touches to cancel the setting of addition to the BET amount. The CASHOUT button 218 is a button that a player touches to have the number of coins corresponding to a player's own credit amount to be paid out in bar coded tickets to be printed by the ticket printer 116. The BET amount display area 219 displays the total BET amount that a player sets for this race. The payout amount display area 220 displays a payout amount of this race. The credit amount display area 221 displays a player's own credit amount.

Touching any of the betting ticket purchase buttons within the betting ticket purchase button display area 206 after touching any of the respective BET buttons 213, 214, 215, and 216, a player can execute BET operation of the quinella-type bet. For example, if a player touches the betting ticket purchase button for “1-2” in the betting ticket purchase button display area 206 after touching the 10 BET button 215, the player can set addition of “10” to the present BET amount for a combination of No. 1 and No. 2, as a combination of horse numbers that the player forecasts will finish in the first or second places in no particular order. The present BET amount for respective combinations of horse numbers are displayed next to the betting ticket purchase buttons corresponding to the respective combinations.

Although the BET image shown in FIG. 7 is for the quinella-type bet, such respective types of betting as win, place, bracket quinella, quinella place, exacta, trio, trifecta, etc. are also available, and every time a player touches the betting ticket switch button 222, the BET image changes to a BET image of a different type.

Various data in the BET image such as horse names and odds, etc. is included in data on the main game race information transmitted by the main game unit 11 in S1002 above.

Referring back to FIG. 6, in S102, the sub control unit 102 executes a BET operation acceptance process. In this process, based on a coordinate signal from the touch panel driving circuit 122, the CPU 131 identifies a player's BET operation for this race and stores it in the RAM 132. The CPU 131 also checks time when each BET operation is executed and stores it in the RAM 132. The CPU 131 reflects the BET operation of that player on the display of the BET image on the sub monitor 113.

In S103, the sub control unit 102 determines whether or not the BET time has elapsed. In this determination, the CPU 131 checks time until the BET time has elapsed. The BET time is computed by the CPU 131 based on the data on the main game race information transmitted by the main game unit 11 in S1002 above, and begins before this race starts and ends at predetermined timing while this race is in progress.

In addition, the sub control unit 102 may judge that the BET time has elapsed, when the remaining time displayed in the remaining bet time display area 212 on the BET image of the sub monitor 113 runs out.

Till the BET time elapses (S103: NO), the sub control unit 102 returns to S102 above, and continues with the BET operation acceptance process. When the BET time has elapsed (S103: YES), the sub control unit 102 proceeds to S104 and determines whether or not there is a BET. In this determination, the CPU 131 determines whether or not there is any BET setting for this race based on what is stored in S102 above.

Only when the CPU 131 determines that there is a BET (S104: YES), the sub control unit 102 proceeds to S105 and transmits the BET information. In this transmission, the CPU 131 transmits to the main game unit 11 data on what is stored in S102 above, as BET information.

In S106, the sub control unit 102 performs a bonus game execution determination process. In this process, unless a player has set the BET amount on this race by the time when this race starts, the CPU 113 determines not to execute a bonus game. In contrast, if the player has set the BET amount on this race by the time when this race starts, the CPU 131 randomly determines whether or not to execute a bonus game. When the CPU 131 determines to execute a bonus game, it sets up a flag secured in the RAM 132. In addition, when the CPU 131 determines not to execute a bonus game, the flag secured in the RAM 132 is put down.

In S107, the sub control unit 102 executes a main game payout process. In this process, the CPU 131 updates the player's own credit amount stored in the RAM 132 based on the data on the main game payout information transmitted by the main game unit 11 in S1006 above and updates the payout amount display area 220 or credit amount display area 221 on the BET image of the sub monitor 113.

In S108, the sub control unit 102 determines whether or not to execute a bonus game. The CPU 131 makes this determination based on the flag secured in the RAM 132.

Only when the sub control unit 102 has determined to execute a bonus game in S108 above (S108: YES), and proceeds to S109 and executes a bonus game process. The bonus game process is described later.

### [6. Example of a Bonus Game]

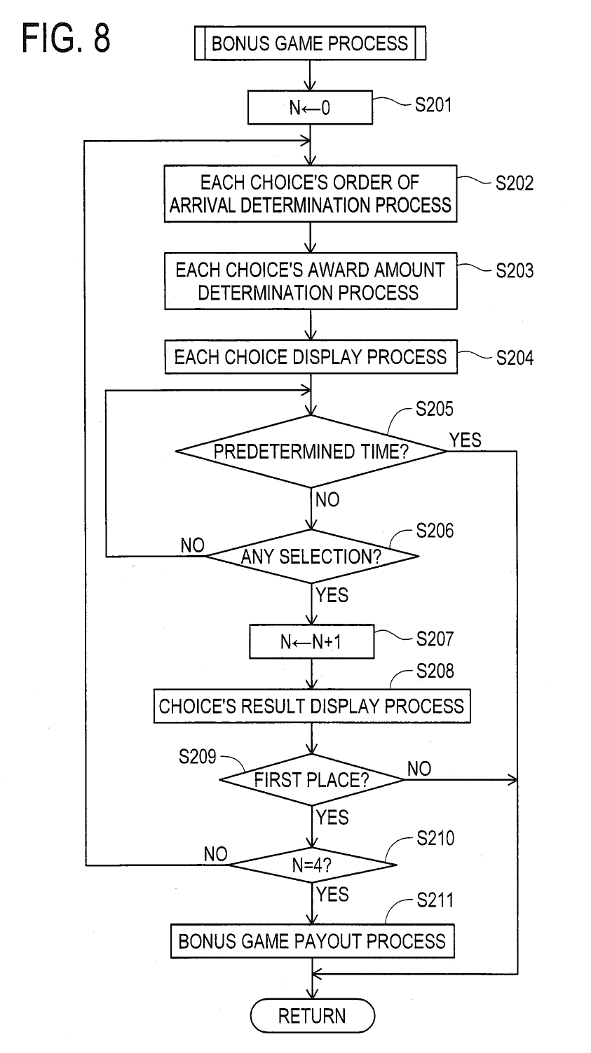

Next, a description is made on an example of a bonus game in the gaming machine 1 of this embodiment. FIG. 8 is a flow chart showing one example of the bonus game process.

In each station 101, the bonus game process of S109 in the aforementioned FIG. 6 is executed based on the flow chart of FIG. 8.

First, in S201, the sub control unit 102 assigns “0” to a variable N. In this process, the CPU 131 writes “0” into the storage area of the variable N secured in the RAM 132.

In S202, the sub control unit 102 executes an each choice's order of arrival determination process. In this process, the CPU 131 randomly relates any one of three first places, two second places, and one third place to each of the six choices W1 to W6 provided on the bonus game image.

In S203, the sub control unit 102 executes an each choice's award amount determination process. In this process, the CPU 131 randomly relates an award amount within the range of “100” to “300” to the three choices W related to the first place, among the respective choices W1 to W6 provided on the bonus game image.

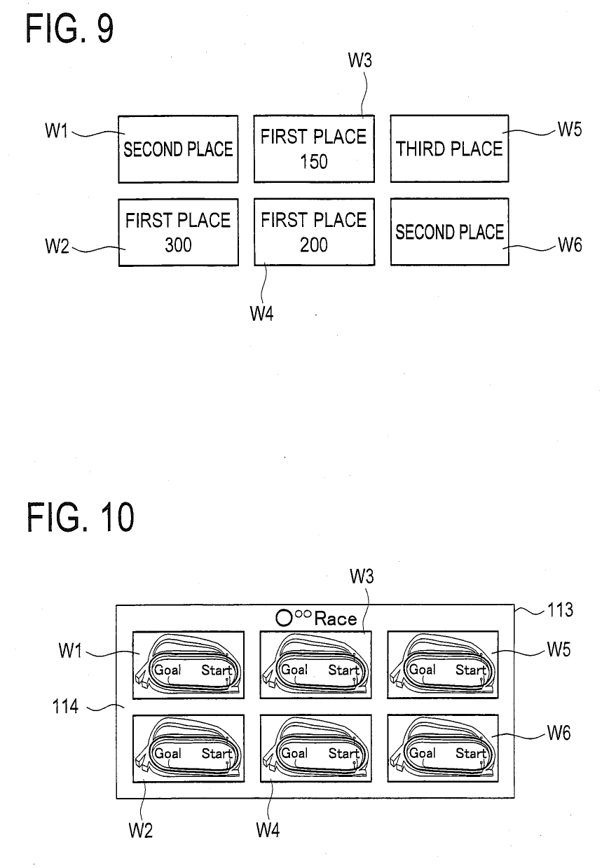

FIG. 9 is a view showing one example of the orders of arrival and award amounts related to the respective choices W1 to W6 on the bonus game image. In the case of the example shown in FIG. 9, in S202 above, the first place is related to each of the choices W2, W3, and W4. In addition, in S203 above, with the award “300” is related to the choice W2, the award “150” is related to the choice W3, and the award “200” is related to the choice W4.

Now referring back to FIG. 8, in S204, the sub control unit 102 executes an each choice display process. In this process, the CPU 131 displays the bonus game image on the sub monitor 113. FIG. 10 is a front view showing one example of the bonus game image to be displayed on the sub monitor 113. In the case of the example shown in FIG. 10, the six choices W1 to W6 are aligned and displayed, and an overall view of the race track is displayed in the each choice W1 to W6.

Now referring back to FIG. 8, in S205, the sub control unit 102 determines whether the present time is predetermined time. In this determination, the CPU 131 checks time until the limit time of the bonus game is reached.

If the limit time of the bonus game has not been reached (S205: NO), the sub control unit 102 proceeds to S206 and determines whether or not there is any selection. In this determination, the CPU 131 determines whether or not there is a choice on the bonus game image of the sub monitor 113, based on a coordinate signal from the touch panel driving circuit 122.

If there is no selection (S206: NO), the sub control unit 102 returns to S205 above. If there is any selection (S206: YES), the sub control unit 102 proceeds to S207 and adds “1” to the variable N. In this process, the CPU 131 adds “1” to the storage area of the variable N secured in the RAM 132.

In S208, the sub control unit 102 executes a choice's result display process. In this process, based on the coordinate signal from the touch panel driving circuit 122, the CPU 131 identifies the choice W that the player selected by touching it via the touch panel 114, among the respective choices W1 to W6 provided on the bonus game image of the sub monitor 113, and displays overlapping on the choice W the order of arrival and award amount related to the choice W that is a target of that identification. For instance, on the bonus game image in the top column of FIG. 1 above, the player has selected the choice W2, and the first place and the award amount of “300” are displayed overlapping on that choice W2.

Referring back to FIG. 8, in S209, the sub control unit 102 determines whether or not the order of arrival is the first place. In this determination, the CPU 131 determines whether or not the order of arrival displayed in S208 above is the first place.

If it is the first place (S209: YES), the sub control unit 102 proceeds to S210 and determines whether or not the variable N is “4”. The CPU 131 makes this determination based on what is in the storage area of the variable N secured in the RAM 132.

If the variable N is not “4” (S210: NO), the sub control unit 102 returns to S202 above. If the variable N is “4” (S210: YES), the sub control unit 102 proceeds to S211 and executes a bonus game payout process. In this process, the CPU 131 sums up the award amount displayed in each S208 above, and adds it to the player's own credit amount stored in the RAM 132.

If the sub control unit 102 proceeds to S211, it means that so far a series of processes from S202 to S210 described above have been repeated four times. One example of the bonus game image when the repetition of 4 times was done is displayed in FIG. 1 above. A first round is the case in which the bonus game image of the first time is displayed on the sub monitor 113; a second round is the case in which the bonus game image of the second time is displayed; a third round is the case in which the bonus game image of the third time is displayed, and a fourth round is the case in which the bonus game image of the fourth time is displayed.

In the example shown in FIG. 1, the bonus game image at the time when the processes are executed for the first time (first round) is displayed on the top column, wherein the player has selected the choice W2 via the touch panel 114, and the first place and the award amount of “300” are displayed overlapping on the selected choice W2 on the sub monitor 113. The bonus game image at the time when the processes are executed for the second time (second round) is displayed on the second column from the top, wherein the player has selected the choice W5 via the touch panel 114, and the first place and the award amount of “200” are displayed overlapping on the selected choice W5 on the sub monitor 113. The bonus game image at the time when the processes are executed for the third time (third round) is displayed in the third column from the top, wherein the player has selected the choice W4 via the touch panel 114, and the first place and the award amount of “200” are displayed overlapping on the selected choice W4 on the sub monitor 113. The bonus game image at the time when the processes are executed for the fourth time (fourth round) is displayed on the fourth column from the top, wherein the player has selected the choice W1 via the touch panel 114, and the first place and the award amount of “150” are displayed overlapping on the selected choice W1 on the sub monitor 113.

Thus, in the example shown in FIG. 1, the respective award amounts of “300”, “200”, “200”, and “150” are displayed in this order on the sub monitor 113 (S208), and “850” that is a total of the respective award amounts will be added to the player's own credit amount (S211). The CPU 131 controls so that a total value of award amounts, etc. won by the player is displayed in the bonus game image of the sub monitor 113. In addition, the CPU 131 performs relating of the orders of arrival to the award amounts of the respective choices W1 to W6 on the bonus game image of each round, whenever a series of processes from S202 to S210 above are repeated (S202, S203).

In contrast, if the player did not make selections (S205: YES) from the first to the fourth rounds by the time limit of the bonus game, or if the order of arrival of the choice W selected by the player in each round is not the first place (S209: NO), S211 will not be executed and thus no player will win an award in this bonus game.

The number of rounds, the number of choices in the bonus game image, the number of first places, the range of award amounts, etc. in the description of the aforementioned bonus game are simply one example, and they are not limited to the case in the aforementioned description.

### [7. Others]

The present invention shall not be limited to the aforementioned embodiment and various changes can be made within the scope of the invention.

As an example of a modification of the bonus game image, FIG. 13 shows a bonus game image to be displayed on the sub monitor 113. In the example shown in FIG. 13, the bonus game image on which 12 choices W1 to W12 are provided is displayed on the sub monitor 113. If a player selects one choice W on this bonus game image, the order of arrival and award amount related to the choice W are displayed. Only if this order of arrival is the first place, the player is allowed to make a next choice. If the order of arrival of the choice W the player selected for the fourth time is also the first place, on the condition that the player selected for the fourth time before finishing of racing on the main monitor 21, the award amounts in the selections of the respective rounds are summed up and added to the player's own credit amount.

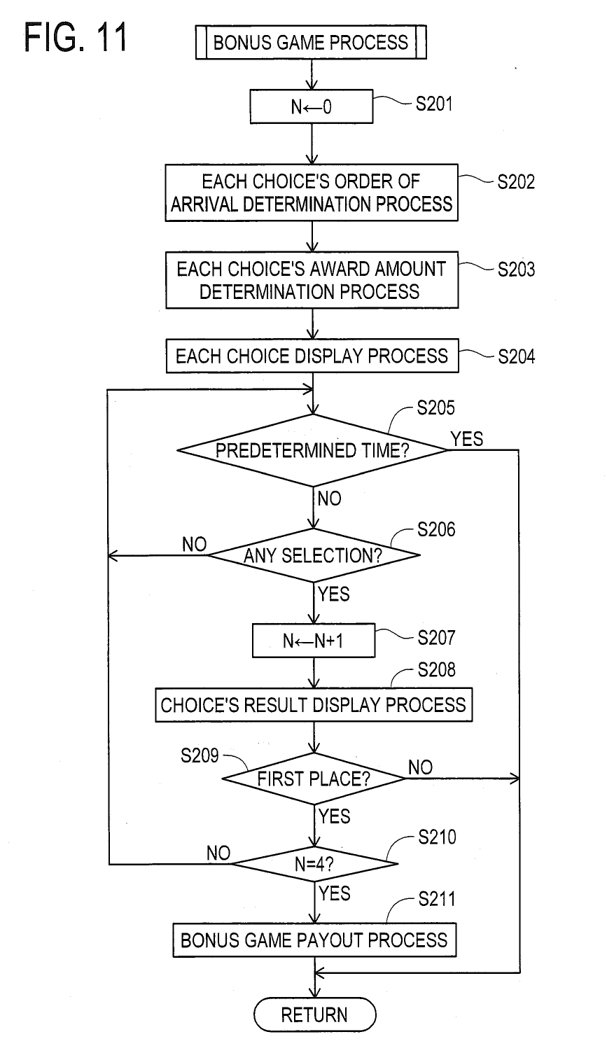

The flow chart of FIG. 11 shows one example of the bonus game process for executing such a bonus game. Each station 101 executes the bonus game process of S109 in FIG. 6 above, based on the flow chart of FIG. 11. As the flow chart of FIG. 11 is same as that of the aforementioned FIG. 8 except for the following points, the diagrammatic representation is made by using same symbols and similar explanations are omitted.

In the each choice's order of arrival determination process executed in S202 by the sub control unit 102, the CPU 131 randomly relates any one of six first places, four second places, and two third places to the 12 choices W1 to W12 provided on the bonus game image.

In the each choice's award amount determination process executed in S203 by the sub control unit 102, the CPU 131 randomly relates award amounts within the range of “100” to “300” to the six choices W corresponding to the first place of the order of arrival, among the respective choices W1 to W12 provided on the bonus game image.

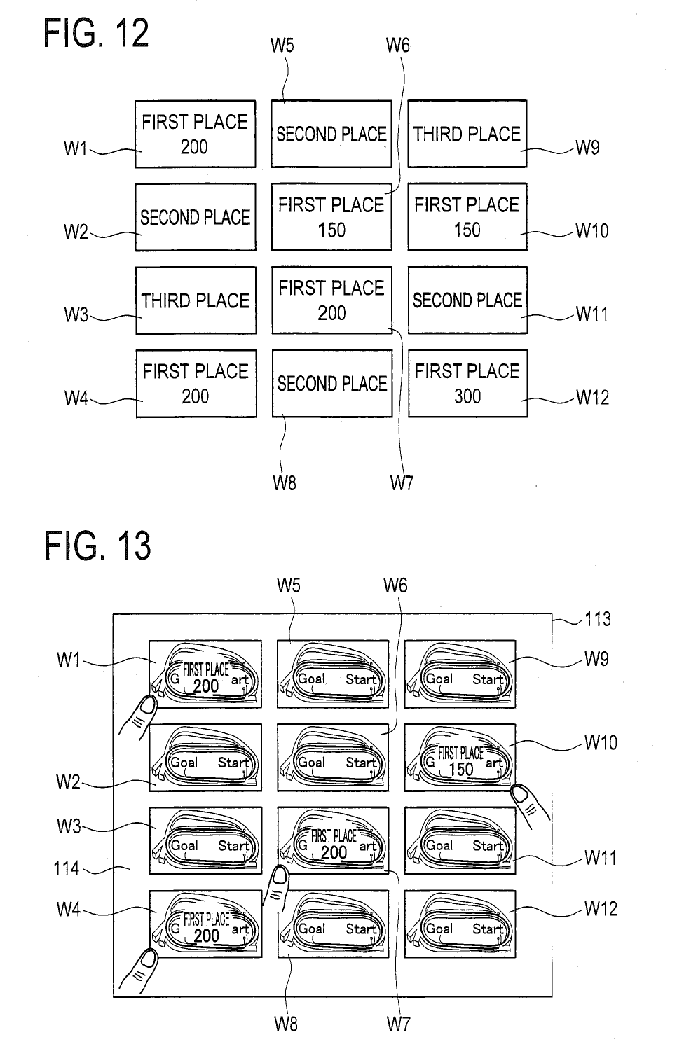

FIG. 12 is a view showing one example of the orders of arrival and award amounts related to the respective choices W1 to W12 of the bonus game image. In the case of the example shown in FIG. 12, the order of arrival of the first place is related to the choices W1, W4, W6, W7, W10 and W12, respectively, in S202 above. In addition, in the aforementioned S203, the award “200” is related to the choice W1, the award “200” is related to the choice W4, the award “150” is related to the choice W6, the award “200” is related to the choice W7, the award “150” is related to the choice W10, and the award “300” is related to the choice W12.

Referring back to FIG. 11, the sub control unit 102 returns to the aforementioned S205 if the variable N is not “4” (S210: NO).

Thus, in this variant example, if the sub control unit 102 proceeds to S211, it means that so far a series of processes from the aforementioned S205 to S210 have been repeated four times. The aforementioned FIG. 13 shows one example of the bonus game image in which the repetition of the four times has been made.

In the example shown in FIG. 13, the player has selected the choices W1, W4, W6, and W10 via the touch panel 114, and the orders of arrival related to any of the choices W1, W4, W6, and W10 is the first place. Thus, in the choices W1, W4, W6 and W10, after the player has selected them, the first place and the award amount thereof are displayed overlapping on the sub monitor 113.

In the example shown in FIG. 13, “200”, “200”, “200”, and “150” are displayed on the sub monitor 113 as the award amounts related to the choice W selected by the player (S208), and “750” that is a total of the respective award amounts will be added to the player's own credit amount (S211). In addition, the CPU 131 performs once relating the orders of arrival to the award amounts of the respective choices W1 to W12 on the bonus game image in the aforementioned S202 and S203.

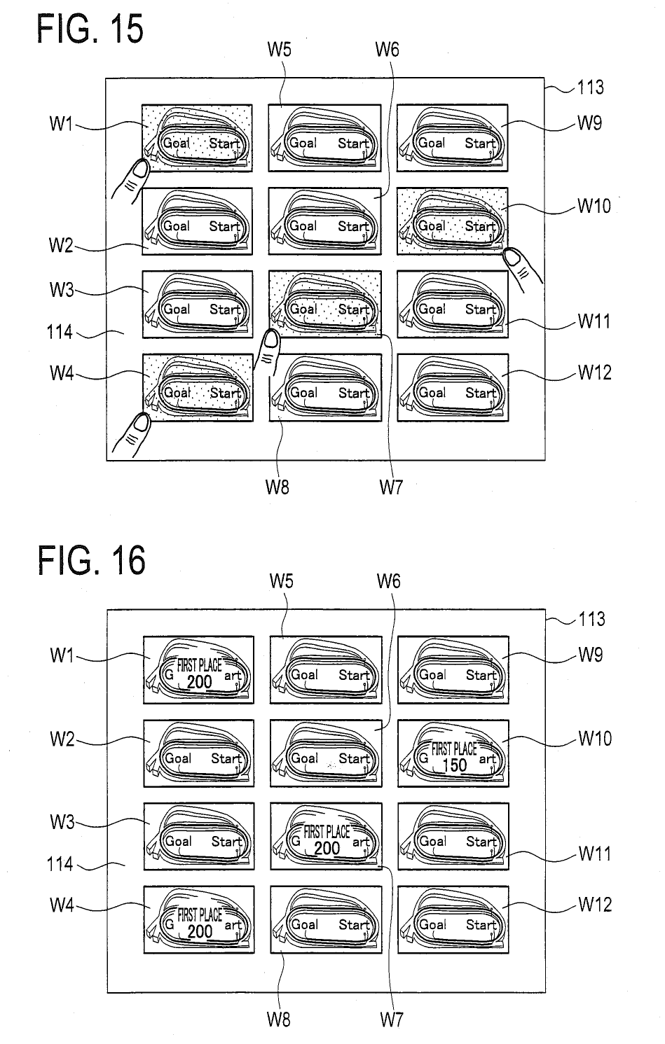

In addition, as another variant example, FIG. 15 and FIG. 16 each show a bonus game image to be displayed on the sub monitor 113. Also in this variant example, as shown in FIG. 15, the bonus game image on which 12 choices W1 to W12 are provided is displayed on the sub monitor 113. However, on this bonus game image, when the player selects the choice W, that choice W is highlighted, and the orders of arrival and award amounts related to those choices W are displayed all together, as shown in FIG. 16, after the player selected four choices W. If the orders of arrival of the four choices W selected by the player are all the first places, the award amounts of those choices W are summed up and added to the player's own credit amount.

For convenience of this explanation, it should be noted that, in FIG. 15 and FIG. 16, the order of arrivals and places related to the respective choices W1 to W12 are similar to the aforementioned FIG. 12, and the fact that the player selected the choices W1, W4, W6 and W10 is also similar to the aforementioned FIG. 13.

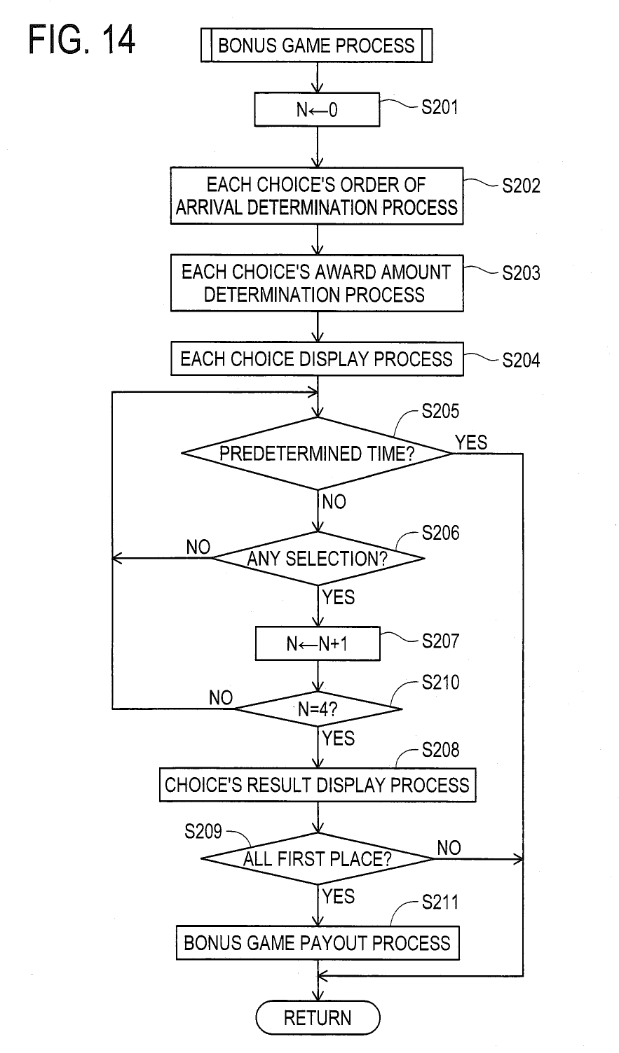

The flow chart of FIG. 14 shows one example of the bonus game process for executing such the bonus game. Each station 101 executes the bonus game process in S109 of the aforementioned FIG. 6 based on the flow chart of FIG. 14. As the flow chart of FIG. 14 is same as that of the aforementioned FIG. 11 except for the following points, the diagrammatic representation is made by using same symbols and similar explanations are omitted.

In the determination made by the sub control unit 102 in S206, if there is a choice (S206: YES), the CPU 131 highlights that selected choice W on the bonus game image of the sub monitor 113 and then proceeds to the aforementioned S207.

The determination that the sub control unit 102 makes in S210 is executed after the aforementioned S207. If the variable N is “4” (S210: YES), the sub control unit 102 proceeds to the aforementioned S208.

In the determination made by the sub control unit 102 in S209, the CPU 131 determines whether or not all orders of arrival displayed in the aforementioned S208 are the first places.

The bonus game payout process to be executed by the sub control unit 102 in S211 is executed by the CPU 131 on the condition that the CPU 131 determined in the aforementioned S209 that the orders of arrival are all the first places.

Thus, in this variant example, when the sub control unit 102 proceeds to S208, it means that so far a series of processes from the aforementioned S205 to S207 and those up to S210 have been repeated four times. The aforementioned FIG. 15 is one example of the bonus game image while this repetition of four times is being done, and the aforementioned FIG. 16 is one example of the bonus game image after this repetition of four times is done.

The number of choices, the number of selections, the number of first places, the range of award amounts, etc. on the bonus game image in the description of the variant example of the aforementioned each bonus game are simply one example, and they are not limited to the case in the aforementioned description.

In addition, although the aforementioned each bonus game is executed after the end of this race of a horse racing game as a main game, it may be started and ended while this race of the horse racing game as the main game is in progress. To this end, first, in the determination that the sub control unit 102 makes in S205 in each bonus game process of FIG. 8, FIG. 11, and FIG. 14, it is determined whether or not the present time is the race end time of the main game. In this determination, the CPU 131 checks the time until the time to end this race is reached. In addition, the time to end this race is contained in the data on the main game race information transmitted by the main game unit 11 in S102 in the aforementioned FIG. 6.

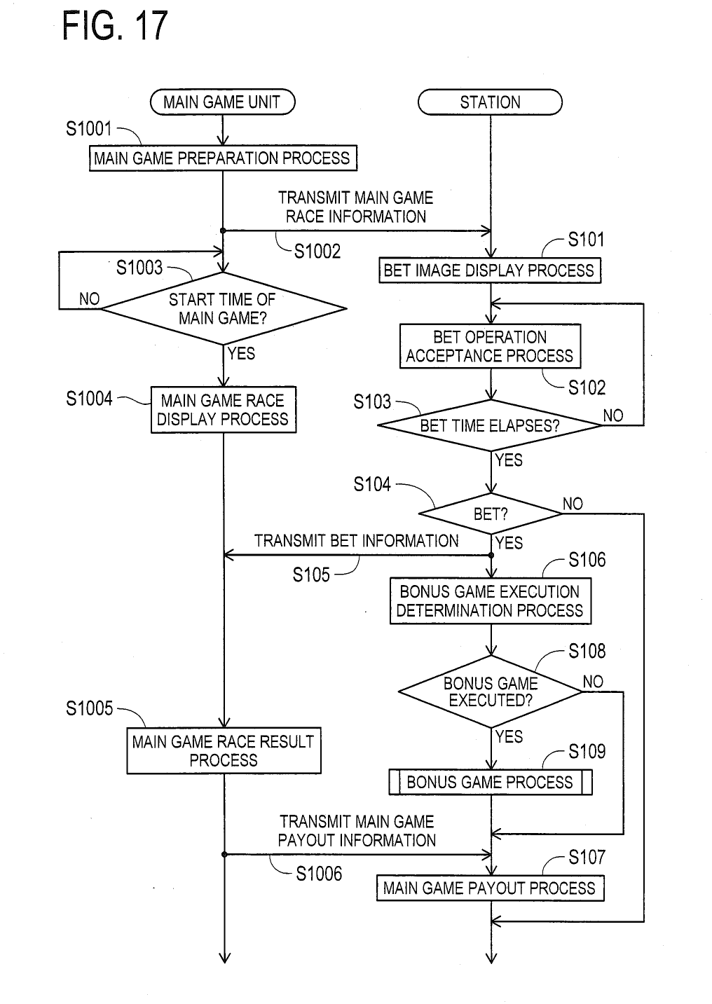

In addition, the game operation in the gaming machine 1 of this embodiment is performed based on the flow chart of FIG. 17, for example. As the flow chart of FIG. 17 is same as that of the aforementioned FIG. 6 except for the following points, the diagrammatic representation is made by using same symbols and similar explanations are omitted.

The determination to be made by the sub control unit 102 in S108 is made by the CPU 131 after the aforementioned S106.

The bonus game process to be executed by the sub control unit 102 in S109 is executed on the condition that the CPU 131 determined in the aforementioned S108 that the bonus game is executed (S108: YES).

The payout process of the main game to be executed by the sub control unit 102 in S107 is executed after the CPU 131 determined in the aforementioned S108 that the bonus game is not executed (S108: NO) or after the aforementioned S109.

In addition, the horse racing game that is the main game and the bonus game may be executed not as a game using a machine such as described above but as a table game.

In addition, the main game shall not be limited to the horse racing game, and it may be a racing game of any other animal such as dogs, as far as it is the racing game. In addition, it may be even a racing game of a racing, swimming racing, boat racing, motorcar racing, motorcycle racing, etc.

What is claimed is:

1. A gaming machine, comprising:
a main monitor on which a racing game is displayed;
a plurality of stations respectively provided with a sub monitor on which play information on the racing game is displayed and an input device which accepts a bet operation by a player for the racing game; and
a processor which controls the main monitor and the plurality of stations and is programmed, to the stations where the player executed the bet operation for the racing game with the input device, to execute the following processes from (a) to (c):
(a) randomly determining whether or not to execute a bonus game before starting the racing game on the main monitor;
(b) starting the bonus game on the sub monitor when it is determined in the (a) that the bonus game is executed; and
(c) awarding the player a prize depending on the result of the bonus game which was progressed based on the input operation of the player through the input device.

2. The gaming machine according to claim 1, wherein when executing control such as the (b), the processor is programmed to execute the following process (1):
(1) starting the bonus game on the sub monitor after ending of the racing game, if it was determined in the (a) that the bonus game is executed.

3. The gaming machine according to claim 1, wherein when executing control such as the (b), the processor is programmed to execute the following process (1):
(1) starting the bonus game on the sub monitor, while the racing game is proceeding, if it was determined in the (a) that the bonus game is executed.

4. The gaming machine according to claim 1, wherein the processor is programmed to execute the following processes from (1) to (3) when executing control such as the (c):
(1) constructing the bonus game by sequentially executing stages several times in which, through operation of the input device, the player selects one of a plurality of choices in which random combinations of order of arrival and prize are respectively related and simultaneously displayed on the sub monitor;
(2) proceeding to a next stage if the order of arrival corresponding to the choice selected by the player is a predetermined order of arrival; and
(3) awarding the player all of the prizes corresponding to the respective choices which selected by the player in the respective stages from the first stage to the last stage only when the order of arrival corresponding to the choice which the player selected in the last stage is the predetermined order of arrival.

5. The gaming machine according to claim 1, wherein the processor is programmed to execute the following processes from (1) to (2) when executing control such as the (c):
(1) constructing the bonus game by sequentially executing stages several times in which, through operation of the input device, the player selects one of a plurality of choices in which random combinations of order of arrival and prize are respectively related and simultaneously displayed on the sub monitor;
(2) awarding the player all of the prizes corresponding to the respective choices which selected by the player only when each of the orders of arrival corresponding to the respective choices selected by the player is a predetermined order of arrival.

6. A method of playing a game, comprising the following steps from (a) to (c) for a player who bet on a racing game:
(a) randomly determining whether or not to execute a bonus game before starting the racing game;
(b) starting the bonus game when it is determined in the (a) that the bonus game is executed; and
(c) awarding the player a prize depending to the result of the bonus game that was progressed based on instructions of the player.

7. The method of playing a game according to claim 6, further comprising the following step (1): so as to make the step (b),
(1) starting the bonus game after ending of the racing game, if it was determined in the (a) that the bonus game is executed.

8. The method of playing a game according to claim 6, further comprising the following step (1): so as to make the step (b),
(1) starting the bonus game while the racing game is proceeding, if it was determined in the (a) that the bonus game is executed.

9. The method of playing a game according to claim 6, further comprising the following step (1) from (3): so as to make the step (c),
(1) constructing the bonus game by sequentially executing a stage several times in which the player selects one of a plurality of choices in which random combinations of order of arrival and prize are respectively related;
(2) proceeding to a next stage if the order of arrival corresponding to the choice selected by the player is a predetermined order of arrival; and
(3) awarding the player all of the prizes corresponding to the respective choices which selected by the player in the respective stages from the first stage to the last stage only when the order of arrival corresponding to the choice that the player selected in the last stage is the predetermined order of arrival.

10. The method of playing a game according to claim 6, further comprising the following step (1) from (2): so as to make the step (c),
(1) constructing the bonus game by sequentially executing stages several times in which the player selects one of a plurality of choices in which random combinations of order of arrival and prize are respectively related;
(2) awarding the player all of the prizes corresponding to the respective choices which selected by the player only when each of the orders of arrival corresponding to the respective choices selected by the player is a predetermined order of arrival.
